(19) United States
(12) Patent Application Publication
(10) Pub. No.: US 2007/0234019 A1
(43) Pub. Date: Oct. 4, 2007

(54) Processor apparatus and complex condition processing method

(75) Inventor: Masaru Terashima, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/723,623

(22) Filed: Mar. 21, 2007

(30) Foreign Application Priority Data
Mar. 30, 2006 (JP) 2006-094589

(51) Int. Cl. G06F 9/44

(52) U.S. Cl. 712/234

(57) ABSTRACT

Disclosed is a processor apparatus that has an instruction set that includes a complex conditional branch instruction that performs comparison operations corresponding to one or more conditions and causes a branch to a specified branch destination to be taken, based on a comparison operation between a result of the comparison operations and a specified branch condition value; and a condition setting instruction that sets a condition. The apparatus includes a plurality of condition setting/comparison units each of which is selected by an execution of the condition setting instruction, in each of which a condition specified by the condition setting instruction is set and, when the complex conditional branch instruction is executed, each of which performs a comparison operation corresponding to the condition specified by the condition setting instruction; and a complex conditional branch determination unit that determines whether to cause the branch to the branch destination to be taken or not, based on a result of a comparison between a result of the comparison operations of the plurality of condition setting/comparison units and the branch condition value specified by the complex conditional branch instruction.

### FIELD OF THE INVENTION

The present invention relates to a processor that fetches, decodes, and executes an instruction, and more particularly to a method and device for complex conditional branch processing.

### BACKGROUND OF THE INVENTION

One of this type of complex condition processing methods is disclosed, for example, in Patent Document 1. The configuration disclosed in this document for processing multiple instructions in parallel comprises flag register means in which the bits can be set/reset independently and in parallel according to the truth/false values of the execution result of multiple comparison instructions, logical product means that calculates a bit-basis logical product between the content held in this flag register means and a mask value specified by a conditional branch instruction, and instruction fetch address selection means that selects either the branch destination address specified by the conditional branch instruction or the address of the instruction immediately following the branch instruction as the address of the instruction to be executed next according to whether or not the output value of the logical product means is 0. In this configuration, whether to cause a branch to be taken or not is determined with the states of respective bit positions in the flag register, specified by the mask value, as a complex condition.

The parallel processor apparatus disclosed in Patent Document 1 has multiple comparison instruction decoders to execute multiple comparison instructions at the same time and, with the execution result stored in the flag register, causes a conditional branch to be taken according to the state of the flag register.

The complex condition processing method disclosed in Patent Document 1 will be outlined below. In the description, the assembler instructions (the result of compilation) corresponding to a program coded in C language given below are used as an example.

if (X>1 && X<10 && X!=5)

{Processing to be executed if complex condition is true}

In the program coded in C language given above, if the three conditions (X>1, X<10, X!=5) are all true (&& indicates the AND operator), the next instruction, that is, {Processing to be executed if complex condition is true}, is executed. If at least one of the three conditions is false, a branch occurs and {Processing to be executed if complex condition is true} is skipped. According to Patent Document 1, the compilation result of the program coded in C language is as follows:

SLE X, 1, 0 SGE X, 10, 1 SEQ X, 5, 2

BNZ 7, $1

{Processing to be executed if complex condition is true}

$1: (Processing at branch destination)

The instruction “SLE X, 1, 0, . . . ”, which is the first instruction, performs the comparison operation of the complex condition. The SLE comparison instruction, which has the format “SLE A, B, C”, compares A and B and sets bit C (one of bits 0-3) of the flag register to 1 if A<=B and, if not, sets bit C to 0. The SGE comparison instruction, which has the format “SGE A, B, C”, compares A and B and sets bit C (one of bits 0-3) of the flag register to 1 if A>=B and, if not, sets bit C to 0. The SEQ comparison instruction, which has the format “SEQ A, B, C”, compares A and B and sets bit C (one of bits 0-3) of the flag register to 1 if A=B and, if not, sets bit C to 0.

The conditional branch instruction “BNZ 7, $1”, which is the second instruction, performs the bit-by-bit operation between the result of the comparison operation for the complex condition and the branch condition value (mask value) 7 and, if the condition is false, causes a jump to address $1 to be taken. The BNZ conditional branch instruction, which has the format “BNZ M, L”, calculates the logical product between M (4-bit mask value) and the corresponding bits of the flag register. The zero checking circuit checks if all bits of the logical product result are 0 and outputs 1 if all bits are 0, and 0 if not. The output signal (zero/non-zero checking result) of the zero checking circuit is used as the branch/non-branch signal. If the branch condition is satisfied, the BNZ instruction passes control to the address specified by L. In this example, the mask value of “BNZ 7, $1” is 0111, and the BNZ instruction causes a conditional branch to be taken depending upon the values of bits 0-2 of bits 0-3 of the flag register.

As described above, the program uses two instructions: comparison instruction SLE X, 1, 0, . . . and the conditional branch instruction BNZ.

In this exemplary program, if at least one of the three comparison conditions (X>1, x<10, X!=5) for the value X (corresponding to the register) is false, that is, if at least one of comparison conditions (X<=1, X>10, X=5) is true in the Assembler coding, the control jumps to $1. This means that all comparison conditions may also be ORed by inverting the comparison results.

### [Patent Document 1]

Japanese Patent Kokai Publication No. JP-A-5-274143

### SUMMARY OF THE DISCLOSURE

There is no problem with the complex condition processing method described in Patent Document 1 as long as a complex condition is executed only once. However, the complex condition processing method, if used for loop processing in which the same condition is executed repeatedly, generates the problems described below.

A first problem is that each execution of the condition branch processing, in which the complex condition comparison instruction and the conditional branch instruction are executed as a set, requires execution cycles for two steps. The following describes this problem.

As shown in FIG. 10A, the complex condition processing method described in Patent Document 1 requires the cycles for two instructions. In the example in FIG. 10A, six cycles (F(instruction fetch), D(decode), EX(execution), F, D, EX) are required for one set of two instructions, that is, the comparison instruction (SLE X, 1, 0, . . . ) and conditional branch instruction (BNZ) (See 10-1 and 10-2 in FIG. 10A). When the complex condition comparison instruction (SLE X, 1, 0, . . . ) is executed, the comparison operations for the conditions of the complex condition are executed in parallel and the comparison execution result is set in the specified bits of the flag register. After that, the conditional branch instruction (BNZ) determines whether to cause a branch to be taken or not, based on the result of logical operation between the flag register value and the mask value. In the complex condition processing method described in Patent Document 1, the instruction fetch cycle and the instruction decode cycle are required at least twice because there are two separate instructions (comparison instruction and conditional branch instruction). This requirement results in an increase in the number of cycles and, especially, an increase in the number of cycles during loop processing slows the overall processing.

A second problem with the complex condition processing method described in Patent Document 1 is that, because the comparison instruction is configured in such a way that a complex condition is all executed in parallel by one instruction, the length of the instruction representing multiple conditions becomes long.

For example, the comparison instruction

SLE X, 1, 0 SGE X, 10, 1 SEQ X, 5, 2

requires the following number of bits:

Eight bits for the instruction code (assume that the processor has up to 256 types of instruction);

Three bits for the selection of comparator type because there are six types of comparator;

Four bits for the selection of a register if one of 16 registers is selected for the operand X;

Four bits for the condition value of an operand assuming that a value in range of 0-15 can be specified (for example, 1 in “SLE X, 1, 0” corresponds to 1 on the right-hand side of the comparison condition X<=1);

Two bits for the bit position specification (any of bits 0-3) in the flag register of the operand;

and hence the total number of bits is 8+4+(3+4+2)×3=39 bits (see Table 1).

TABLE 1

| Instruction | | | Condition | Flag | | Condition | Flag | | Condition | Flag |
|---|---|---|---|---|---|---|---|---|---|---|
| code | Register | Comparator 0 | value 0 | bit 1 | Comparator 1 | value 1 | bit 2 | Comparator 2 | value 2 | bit 3 |
| 8 bits | 4 bits | 3 bits | 4 bits | 2 | 3 bits | 4 bits | 2 | 3 bits | 4 bits | 2 |
| | | | | bits | | | bits | | | bits |
| | X | LE | 1 | 0 | GE | 10 | 1 | EQ | 5 | 2 |
| XXXX | XXXX | 011 | 0001 | 00 | 101 | 1010 | 01 | 000 | 0101 | 10 |
| XXXX | | | | | | | | | | |

The instruction length becomes longer because the complex condition is specified all by one instruction in the parallel processor apparatus in Patent Document 1.

To solve the above problems, the invention disclosed by this application generally has the configuration described below.

In one aspect of the present invention, a processor apparatus includes: a conditional branch instruction that causes a branch to a branch destination to be taken, depending upon whether or not a condition is true; and a condition setting instruction that sets the condition; a circuit that, when executing the condition setting instruction, sets a condition specified by the condition setting instruction, but does not perform a comparison operation corresponding to the condition; and a circuit that, when executing the conditional branch instruction, performs the comparison operation corresponding to the condition, which has been set in advance by the condition setting instruction, to determine whether to cause a branch to the branch destination to be taken or not, based on a result of the comparison operation.

In the present invention, the conditional branch instruction is a complex branch condition instruction having a complex condition composed of a plurality of conditions for determining whether to cause the branch to be taken or not, a plurality of the condition setting instructions are executed to set the conditions of the complex condition and, when the complex conditional branch instruction is executed, the conditional branch instruction executes comparison operations corresponding to the plurality of the conditions, which have been set in advance, in parallel and, based on a result of the comparison operations, determines whether to cause the branch to be taken or not, whereby conditional branch processing based on the complex condition is performed by one complex conditional branch instruction.

In another aspect of the present invention, a device includes, in an instruction set thereof, a complex conditional branch instruction that performs comparison operations corresponding to one or more conditions and causes a branch to a specified branch destination to be taken, based on a comparison operation between a result of the comparison operations and a specified branch condition value and a condition setting instruction that sets a condition. The apparatus comprises a plurality of condition setting/comparison units each of which is selected by an execution of the condition setting instruction, in each of which a condition specified by the condition setting instruction is set and, when the complex conditional branch instruction is executed, each of which performs a comparison operation corresponding to the condition specified by the condition setting instruction; and a complex conditional branch determination unit that determines whether to cause the branch to the branch destination to be taken or not, based on a result of a comparison between a result of the comparison operations of the plurality of condition setting/comparison units and the branch condition value specified by the complex conditional branch instruction.

In the present invention, the condition setting instruction includes, in an operand thereof, a specification of the condition setting/comparison unit, a type of comparison operation, and two registers in an operation register or one register in the operation register and immediate data to be used in the comparison operation.

In the present invention, the complex conditional branch instruction includes a type of comparison operation in an op code, and the branch condition value and the branch destination in an operand.

In the present invention, the condition setting/comparison unit comprises first and second address registers that store address information on two operation registers to be compared; an immediate value register that stores immediate value data; a comparator selection register that stores a type of comparison operation; and a comparator. When the condition setting instruction is executed, values are set in the first and second address registers or in the first address register and the immediate value register, and in the comparator selection register. When the complex conditional branch instruction is executed, the operation registers specified by the first and second address registers, or the operation register specified by the first address register, is read and the values of the two operation registers read by the specification of the first and second address registers are compared, or the value of the operation register read by the specification of the first address register is compared with the immediate value data, by the comparator.

In the present invention, The apparatus further comprises a plurality of registers in which results of the comparison operations by the plurality of condition setting/comparison units are saved.

In the present invention, the complex conditional branch determination unit comprises a first register that receives an output from an instruction decoder that decodes the complex conditional branch instruction and stores the branch condition value specified by the complex conditional branch instruction, and a second register that stores the type of comparison operation; and a comparator that outputs a comparison result by performing a comparison operation, specified by the second register, for outputs of the plurality of registers, in which the results of the comparison operations by the plurality of condition setting/comparison units are saved, and the branch condition value specified by the first register.

In the present invention, The apparatus further comprises a selector that selects the condition setting/comparison unit specified by the condition setting instruction, based on a decoding result of the condition setting instruction by the instruction decoder.

The apparatus further comprises a jump destination address register that stores a jump destination address specified by the complex conditional branch instruction decoded by the instruction decoder; and a selector that receives a true/false value, which is a result output from the complex conditional branch determination unit, selects the jump destination address if the true/false value is true, selects an address produced by adding one to a program counter value if the true/false value is false, and sets the selected address in the program counter.

In still another aspect of the present invention, a conditional branch processing method for use by a processor, wherein the processor includes, in an instruction set thereof, a conditional branch instruction that causes a branch to a branch destination to be taken, depending upon whether or not a condition is true and a condition setting instruction that sets the condition, comprises the steps of:

(a) setting a condition specified by the condition setting instruction, but without performing a comparison operation corresponding to the condition, when the condition setting instruction is executed, and

(b) executing the comparison operation corresponding to the condition, which has been set in advance by the condition setting instruction, to determine whether to cause the branch to the branch destination to be taken or not, based on a result of the comparison operation, when the conditional branch instruction is executed.

In the method according to the present invention, the conditional branch instruction is a complex branch condition instruction including a complex condition composed of a plurality of conditions for determining whether to cause the branch to be taken or not. A plurality of the condition setting instructions are executed to set the conditions of the complex condition and, when the complex conditional branch instruction is executed, the conditional branch instruction executes comparison operations corresponding to the plurality of the conditions, which have been set in advance, in parallel and, based on a result of the comparison operations, determines whether to cause the branch to be taken or not, whereby conditional branch processing based on the complex condition is performed by one complex conditional branch instruction.

The meritorious effects of the present invention are summarized as follows.

According to the present invention, conditional branch processing, which is executed by a combination of two instructions (comparison instruction and conditional branch instruction) in the conventional complex condition processing scheme, can be executed by one complex conditional branch instruction. When applied to loop processing in which the processing is repeated under the same condition, a complex condition is set in advance immediately before the loop processing and, within the loop processing, one complex conditional branch instruction is executed to perform a conditional branch. Therefore, as compared with the conventional complex condition processing scheme in which two instructions are executed to perform a conditional branch, the method according to the present invention ensures high-speed processing.

According to the present invention, the more times the processing under the same condition is repeated, the higher the processing performance becomes.

According to the present invention, because the condition setting instruction sets one condition, the length of the instruction is shorter than that of an instruction that sets multiple conditions at a time.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the configuration of one example of the present invention.

FIG. 2 is a diagram showing a condition setting/comparison unit and its related parts in one example of the present invention.

FIG. 3 is a diagram showing a condition setting/comparison unit and its related parts in one example of the present invention.

FIG. 4 is a diagram showing a condition setting/comparison unit and its related parts in one example of the present invention.

FIG. 5 is a diagram showing a complex conditional branch determination unit and its related parts in one example of the present invention.

FIG. 6 is a diagram showing condition setting instructions and a complex conditional branch instruction coded in Assembler in one example of the present invention.

FIG. 7 is a time chart showing the operation of the condition setting instruction in one example of the present invention.

FIG. 8 is a time chart showing the operation of the complex conditional branch instruction in one example of the present invention.

FIGS. 9A and 9B are diagrams showing one example of the present invention and showing the bit-to-bit correspondence between the comparison operation result of a complex condition and a branch condition.

FIGS. 10A and 10B are time charts showing the operation of complex condition processing when loop processing is applied to the complex condition processing method in Patent Document 1.

### EXEMPLARY EXAMPLE OF THE INVENTION

The present invention described above will be described more in detail below with reference to the attached drawings.

The present invention, applicable to a sequential execution type computer, provides a condition setting instruction that sets a comparison condition to be used for determining whether to cause a branch to be taken or not, and this condition setting instruction is executed before a complex conditional branch instruction to set multiple comparison conditions of a complex condition in advance. The present invention provides means that, when the complex conditional branch instruction is executed, executes comparison operations corresponding to the conditions of the complex condition, which have been set, and determines whether to cause a branch to be taken or not, based on the result of the comparison between the comparison operation result with a branch condition value specified by the instruction code.

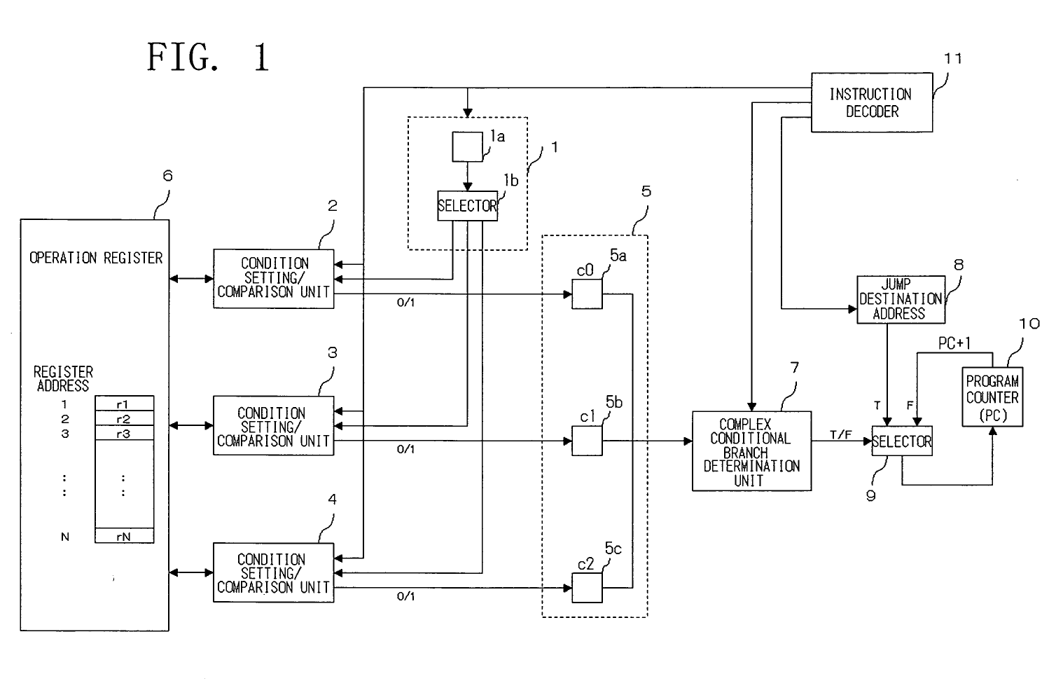

More specifically, a processor apparatus in a preferred mode of the present invention includes, in its instruction set, a condition setting instruction (op code: SETCMP) that sets a comparison condition to be used in determining whether to cause a branch to be taken or not, and a complex conditional branch instruction (op code: XBEQ, XBNE, XBL, XBLE, XBG and XBGE) that performs a comparison operation corresponding to the comparison condition specified by the condition setting instruction and determines whether to cause a branch to a specified branch destination to be taken or not, based on a comparison operation between the result of the comparison operation and a specified branch condition value. The processor apparatus according to the present invention comprises a plurality of condition setting/comparison units (see 2, 3, and 4 in FIG. 1) each of which is selected by an execution of the condition setting instruction, in each of which a comparison condition (comparison operation type, registers or register and immediate value data to be compared) specified by the condition setting instruction is set and, when the complex conditional branch instruction is executed, each of which performs the comparison operation corresponding to the comparison condition specified by the condition setting instruction; and a complex conditional branch determination unit (7 in FIG. 1) that determines, when the complex conditional branch instruction is executed, whether to cause the branch to the branch destination to be taken or not, based on a result of a comparison between a result of the comparison operations of the plurality of condition setting/comparison units and the branch condition value specified by the complex conditional branch instruction.

In the present invention, the condition setting instruction (SETCMP) includes, in its operand, a specification of the condition setting/comparison unit, a type of comparison operation, and two registers in an operation register or one register in the operation register and immediate data to be used in the comparison operation.

In the present invention, the complex conditional branch instruction includes a type of comparison operation in an op code, and the branch condition value and the branch destination in an operand.

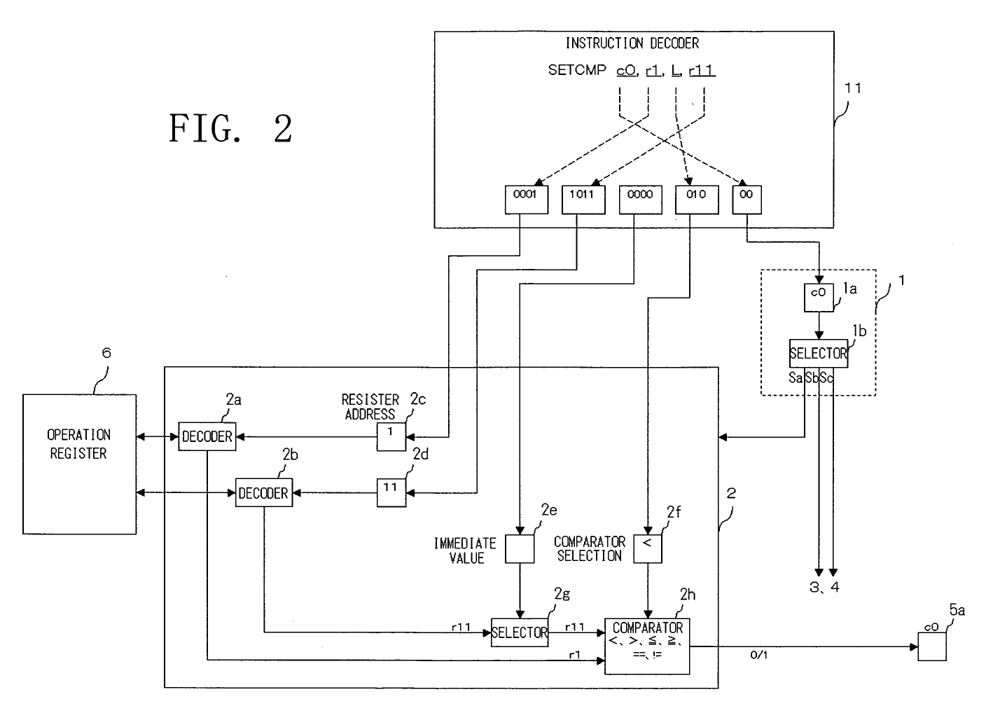

In the present invention, each of the condition setting/comparison units comprises, as shown in FIG. 2, first and second address registers (2c and 2d) that store address information on two registers in an operation register (6); first and second decoders (2a and 2b) that decode the addresses of the first and second address registers (2c and 2d); an immediate value register (2e) that stores immediate value data; a comparator selection register (2f) that stores a type of comparison operation; and a comparator (2h). When the condition setting instruction (SETCMP) is executed, values are set in the first and second address registers (2c and 2d), the immediate value register (2e), and the comparator selection register (2f). When the complex conditional branch instruction is executed, two registers in the operation register (6), selected by the first and second decoders (2a and 2b) that decode the addresses in the first and second address registers (2c and 2d), are read and the values of the two registers that have been read are compared by the comparator (2h), or one register in the operation register (6), selected, for example, by the first decoder (2a) that decodes the address in the first address register (2c), is read and the value of the one register that has been read is compared with the immediate value data by the comparator (2h).

In the present invention, the processor apparatus further comprises a plurality of registers (5a, 5b and 5c in FIG. 1) in which results of the comparison operations by the plurality of condition setting/comparison units (2, 3 and 4 in FIG. 1) are saved.

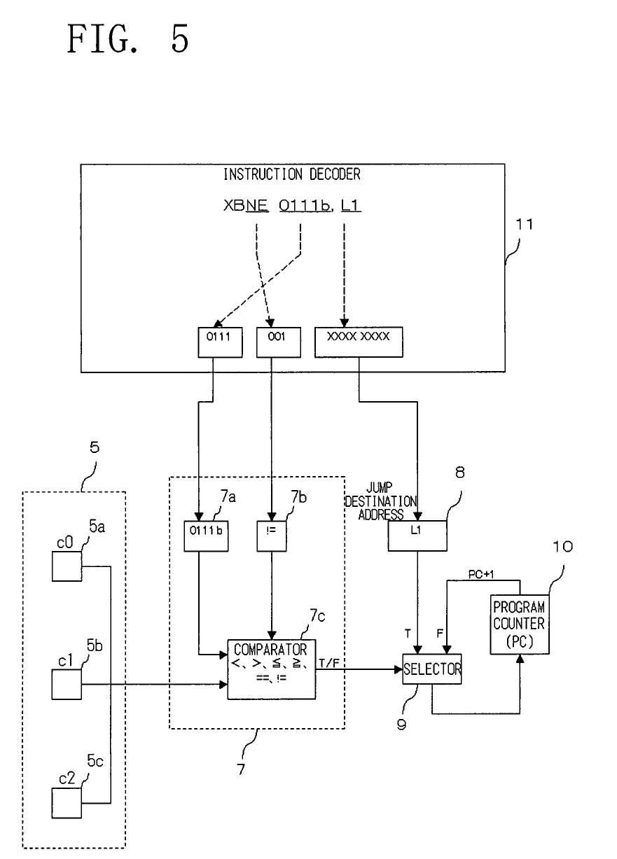

In the present invention, the complex conditional branch determination unit (7 in FIG. 1) comprises, as shown in FIG. 5, a first register (7a) that receives an output from an instruction decoder (11) that decodes the complex conditional branch instruction and stores the branch condition value specified by the complex conditional branch instruction; a second register (7b) that stores the type of comparison operation; and a comparator (7c) that outputs a comparison result by performing a comparison operation, specified by the second register (7b), for outputs of the plurality of registers (5a, 5b and 5c), in which the results of the comparison operations by the plurality of condition setting/comparison units (2, 3 and 4) are stored, and the branch condition value specified by the first register (7a).

In the present invention, the processor apparatus further comprises a selector (1 in FIG. 1) that selects the condition setting/comparison unit specified by the condition setting instruction, based on a decoding result of the condition setting instruction by the instruction decoder (11 in FIG. 1). In the present invention, the processor apparatus further comprises a jump destination address register (8 in FIG. 1) that stores a jump destination address specified by the complex conditional branch instruction decoded by the instruction decoder; and a selector (9 in FIG. 1) that receives a comparison result output from the complex conditional branch determination unit (7 in FIG. 1), selects the jump destination address if the comparison result is true, selects the address of the instruction immediately following the complex conditional branch instruction, that is, an address produced by adding one to the current program counter value, if the comparison result is false, and sets the selected address in the program counter (10 in FIG. 1).

Conditional branch processing, which is executed by a combination of two instructions (comparison instruction and conditional branch instruction) in the conventional complex condition processing scheme disclosed in Patent Document described above, can be executed by one complex conditional branch instruction in the present invention. Therefore, when applied to loop processing in which the processing is repeated under the same condition, a complex condition is set immediately before the loop processing and, within the loop processing, one complex conditional branch instruction is executed to perform a conditional branch. That is, as compared with the conventional complex condition processing scheme in which two instructions are executed to perform a conditional branch, the method according to the present invention ensures high-speed processing.

According to the present invention, the more times the processing under the same condition is repeated, the higher the processing performance becomes.

According to the present invention, because one condition setting instruction sets one condition, the length of the instruction is shorter than that of an instruction that sets multiple conditions at a time as in the conventional complex condition processing scheme. Therefore, the present invention can be easily applied also to a system where the bus width of the instruction memory is relatively narrow.

The following compares the method according to the present invention with the conventional complex condition processing scheme described, for example, in Patent Document 1. The conventional scheme requires six cycles for each execution of a complex condition, while the method according to the present invention, which can execute a conditional branch by one instruction, requires four cycles. When the execution is repeated two or three times, the method according to the present invention requires more execution cycles because the execution step of the condition setting instruction is required in advance. However, in a parallel system where multiple conditions are set by one instruction at a time as in the conventional complex condition processing scheme, a complex condition can be executed by one instruction and, in this case, the complex condition can be executed in the same number of steps as that of the conventional complex condition processing scheme without repeated execution.

In the method according to present invention, a register or immediate data can be specified for each condition. This function, if applied to the conventional complex condition processing scheme, requires additional two sets of bits for specifying registers. Assuming that four bits are required to specify a register, a total of 39+4×2=47 bits are required, as shown in Table 2.

TABLE 2

| Instruction | Register | Comparator | Condition | Flag | Register | Comparator | Condition | Flag | Register | Compar- | Condition | Flag |
|---|---|---|---|---|---|---|---|---|---|---|---|---|
| code | 0 | 0 | value 0 | bit 1 | 1 | 1 | value 1 | bit 2 | 2 | ator 2 | value 2 | bit 3 |
| 8 bits | 4 bits | 3 bits | 4 bits | 2 | 4 bits | 3 bits | 4 bits | 2 | 4 | 3 bits | 4 bits | 2 |
| | | | | bits | | | | bits | bits | | | bits |
| | r1 | LE | 1 | 0 | r2 | GE | 10 | 1 | r3 | EQ | 5 | 2 |
| XXXX | 0001 | 011 | 0001 | 00 | 0010 | 101 | 1010 | 01 | 011 | 000 | 0101 | 010 |
| XXXX | | | | | | | | | | | | |

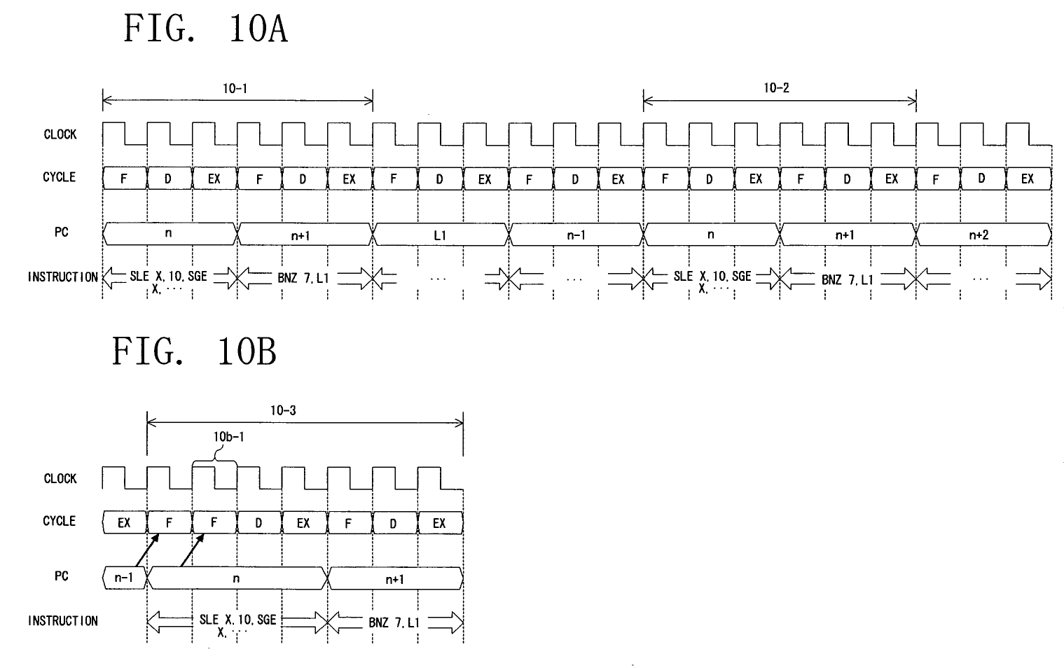

When the instruction memory bus is 32 bits wide, one instruction extends across two instruction memory addresses extends as shown in Table 3. This address specification requires two instruction fetch operations, as shown in 10b-1 in FIG. 10B, and an increase in the number of instruction fetch cycles slows the execution speed of the complex condition comparison instruction.

TABLE 3

| Address | Content of instruction memory |
|---|---|
| n − 1 | XXXX XXXX 0001 011 0001 0010 101 1010 00 |
| n | 0011 000 0101 00000 0000 0000 0000 0000 |

In contrast, both the condition setting instruction and the complex conditional branch instruction can be represented shorter in the method of the present invention than in the conventional scheme. More specifically, the instructions have the following formats.

The condition setting instruction that is a new instruction added to the instruction set by the present invention

SETCMP c0, r1, L, r11

requires two bits for the selection of the condition setting/comparison unit, eight bits for two registers, and three bits for the type of comparator with the total of 8+2+4+4+3=21 bits (see Table 4).

TABLE 4

| Instruction | | | | |
|---|---|---|---|---|
| code | Selection | Register 1 | Comparator | Register 2 |
| 8 bits | 2 bits | 4 bits | 3 bits | 4 bits |
| SETCMP | c0 | r1 | L | r11 |
| XXXX XXXX | 00 | 0001 | 010 | 1011 |

In addition, “SETCMP c1, r2, GE, 10” requires 21 bits when the immediate value is represented by four bits (see Table 5).

TABLE 5

| Instruction | | | | Immediate |
|---|---|---|---|---|
| code | Selection | Register 1 | Comparator | value |
| 8 bits | 2 bits | 4 bits | 3 bits | 4 bits |
| SETCMP | c1 | r2 | GE | 10 |
| XXXX XXXX | 01 | 0010 | 101 | 1010 |

The complex conditional branch instruction that is another instruction added to the instruction set by the present invention

XBNE 0111b, L1

requires eight bits for the instruction code, three bits for the comparator, three bits for the branch condition value that is in the range 0-7, and 16 bits for the jump destination address L1 that specifies the address value of an instruction memory in the 64K word address space, with the total of 8+3+3+16=30 bits. This instruction is shorter than the instruction memory bus width (32 bits) with no increase in the number of instruction fetch cycles (see Table 6).

TABLE 6

| Instruction | | Branch | Jump destination |
|---|---|---|---|
| code | Comparator | condition value | address |
| 8 bits | 3 bits | 3 bits | 16 bits |
| XBNE | NE | 0111b | L1 |
| XXXX XXXX | 001 | 111 | XXXX XXXX |
| | | | XXXX XXXX |

In addition, when the jump destination address is represented by a 12-bit relative address, there are 32−8−3−12=9 extra bits. Although the branch condition value is represented by three bits in an example below, it is also possible to increase the number of bits to specify more complex conditions. In this case, the condition setting/comparison units corresponding to the number of bits are required.

FIG. 1 is a diagram showing the configuration of the main part of a processor in one example of the present invention. Referring to FIG. 1, the processor in this example comprises a selector 1, multiple condition setting/comparison units 2, 3, and 4, a register 5, an operation register 6, a complex conditional branch determination unit 7, a jump destination address register 8, a selector 9, a program counter 10, and an instruction decoder 11. Although there are three condition setting/comparison units in the description, the present invention is not of course limited to three condition setting/comparison units.

The selector 1 comprises a register la that receives the decoding result of the condition setting instruction SETCMP from the instruction decoder 11 (this register stores two bits corresponding to a condition setting/comparison unit specified by the condition setting instruction SETCMP) and a selector 1b that selects one of the condition setting/comparison units 2, 3, and 4 based on the value stored in the register 1a.

Each of the condition setting/comparison units 2, 3, and 4, selected (activated) by the selector 1, sets one condition specified by the condition setting instruction SETCMP and performs the comparison operation corresponding to the condition. Note that the condition setting/comparison units 2, 3, and 4 only set the condition (specify the comparator type, register to be compared, etc.) when the condition setting instruction SETCMP is executed, and perform the comparison operation when the complex conditional branch instruction is executed. This configuration is one of features of the present invention.

The register 5 comprises registers 5a, 5b, and 5c that store the comparison operation results of the condition setting/comparison units 2, 3, and 4 respectively.

The operation register 6 is a register composed of N registers (register files), r1-rN, used by the processor for the operation.

The complex conditional branch determination unit 7 comprises a register 7a (see FIG. 5) that receives the output of the instruction decoder 11, which decodes a complex conditional branch instruction, and stores a branch condition value for comparison specified by the complex conditional branch instruction, a register 7b (see FIG. 5) that stores the comparator type, and a comparator 7c (see FIG. 5) that performs the comparison operation.

The jump destination address register 8 stores the jump address specified by a complex conditional branch instruction decoded by the instruction decoder 11.

The program counter (PC) 10 contains the address of an instruction to be executed by the processor.

The selector 9 receives the address from the jump destination address register 8 and the address of the instruction immediately following the complex conditional branch instruction (program counter value (PC)+1). The selector 9 also receives the true/false value (T/F) of the result, output from the complex conditional branch determination unit 7, as the selection control signal. If the result output from the complex conditional branch determination unit 7 is true, the selector 9 selects the address received from the jump destination address register 8 and, if false, selects the address of the instruction immediately following the complex conditional branch instruction (program counter value (PC)+1). The output from the selector 9 is set in the program counter (PC) 10.

In this example, the following two instructions are added to the instruction set.

Condition setting instruction (SETCMP)

Complex conditional branch instruction (XBNE, XBEQ, etc.)

The condition setting instruction is an instruction that sets a condition for complex condition checking used by the complex conditional branch instruction. The complex conditional branch instruction is an instruction that performs the comparison operation corresponding to the conditions specified by the condition setting instruction, compares the comparison operation results with the branch condition value specified by the instruction code, and causes a branch to be taken, based on the comparison operation result.

First, the following describes the condition setting instruction. In this example, the condition setting instruction is represented by the following assembler mnemonic.

SETCMP c0, r1, L, r11

“SETCMP” represents the name (op code) of the condition setting instruction.

The first operand c0 means the first condition setting and indicates the condition setting/comparison unit 2.

The second and fourth operands, r1 and r11, specify the registers whose addresses are 1 and 11 in the operation register 6.

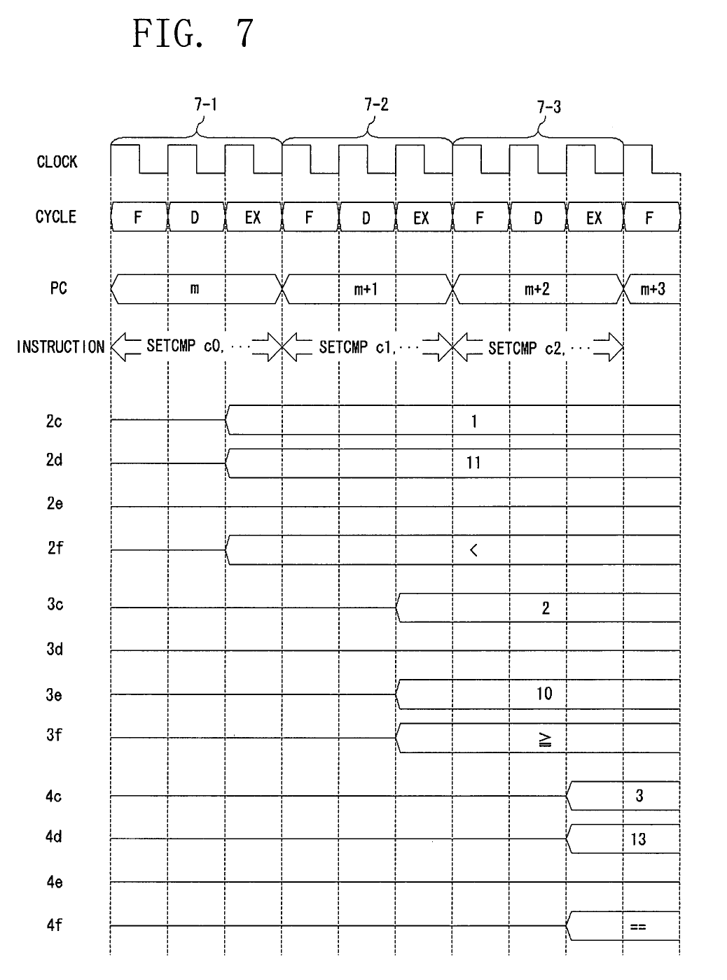

The third operand L represents the type of comparator used for comparing the value in r1 with the value in r11. FIG. 7 is a list of the comparator types as well as their meanings, C language notations, and selection values.

TABLE 7

| Type | | | |
|---|---|---|---|
| (Mnemonic | | C language | |
| notation) | Meaning | notation | Selection value |
| EQ | Equal | ‘==’ | 0(000b) |
| NE | Not Equal | ‘!=’ | 1(001b) |
| L | Less | ‘<’ | 2(010b) |
| LE | Less or Equal | ‘<=’ | 3(011b) |
| G | Greater | ‘>’ | 4(100b) |
| GE | Greater or | ‘>=’ | 5(101b) |
| | Equal | | |

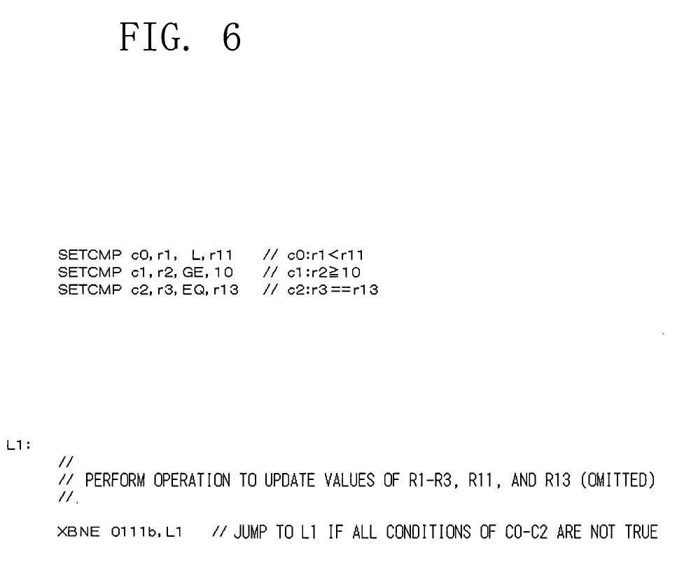

The following describes, with the use of FIG. 6, the actual operation of this example that is performed when the three condition setting instructions in FIG. 6 are executed. A character string after (to the right of) “//” on each line in FIG. 6 is a comment. The three condition setting instructions (SETCMP) in FIG. 6 set the comparison conditions r1<r11, r2>=10, and r3==r13, respectively. In FIG. 6, the instructions on the lines after the label L1, which follow the three condition setting instructions, perform the update operation for the registers r1-r3, r11, and r13 (The instruction codes are not shown in the figure). If none of the conditions C0-C2 is false when the complex conditional branch instruction XBNE, which follows the update operation, is executed, control branches back to the label L1. The lines, from label L1 to the complex conditional branch instruction XBNE, form the loop processing, and the complex conditional branch instruction XBNE checks whether or not control should exit the loop.

When the first condition setting instruction

SETCMP c0, r1, L, r11

is executed, the instruction code is read from the instruction memory (not shown) into the instruction decoder 11 in the instruction fetch cycle F in 7-1 in FIG. 7.

In the instruction decode cycle D that follows the instruction fetch cycle F, the instruction code that has been read is analyzed by the instruction decoder 11 in FIG. 2 as shown in the figure. FIG. 2 schematically shows how the instruction decoder 11 and the condition setting/comparison unit 2, shown in FIG. 1, perform the operation for the following condition setting instruction.

SETCMP c0, r1, L, r11

Referring to FIG. 2, the condition setting/comparison unit 2 comprises resisters (also called address registers) 2c and 2d each of which stores the address of one of the registers in the operation register 6, decoders 2a and 2b that receive the register addresses from the resisters 2c and 2d, decode the received register addresses, and select the corresponding registers from the operation register 6, an immediate value register 2e that stores immediate value data, a comparator selection register 2f, a selector 2g that selects one of the output of the immediate register 2e and the output of the decoder 2b (the value read from a selected one of registers r1 to rN in the operation register 6) and outputs the selected output, and a comparator 2h that receives the output of the decoder 2a (the value read from a selected one of registers r1 to rN in the operation register 6) and the output of the selector 2g and performs the comparison operation selected by a comparator selection register 2f. The condition setting/comparison units 3 and 4 in FIG. 1 have the same configuration as that of the condition setting/comparison unit 2.

The instruction decoder 11 decodes the condition setting instruction

SETCMP c0, r1, L, r11

as follows. That is,

c0 is decoded to 00b (binary),

r1 is decoded to 0001b,

L is decoded to 010b, and

r11 is decoded to 1011b.

At the same time, the instruction decoder 11 stores the value 00b, which is a value indicating the condition setting c0, in the register 1a of the selector 1.

In addition, in the instruction execution cycle Ex that follows the instruction decode cycle D, the selector 1b of the selector 1 selects the condition setting/comparison unit 2 (Sa in the selector 1 in FIG. 2 is activated) because the register 1a of the selector 1 contains c0. The values 0001b, 1011b, and 010b are stored, respectively, from the instruction decoder 11 into the resisters 2c, 2d, and 2f in the condition setting/comparison unit 2.

Note that the values of the resisters 2c-2f are held in the registers even after the condition setting instruction

SETCMP c0, r1, L, r11

is executed. That is, the values of the registers in the condition setting/comparison unit 2 remain unchanged until the next condition setting instruction for the condition setting/comparison unit 2 is executed.

FIG. 2 shows the state in which the operation is performed up to this point in time.

The following values are stored in the condition setting/comparison unit 2 as shown in FIG. 2.

The resister 2c stores the register address 1 (0001b) that indicates the operation register r1.

The resister 2d stores the register address 11 (1011b) that indicates the operation register r11.

The resister 2f stores the value that indicates the comparator type L (This value is represented by 2 (010b) in Table 7, and “<” in FIG. 2A).

In the second condition setting instruction

SETCMP c1, r2, GE, 10

the immediate value 10, not an operation register, is specified for the fourth parameter (fourth operand).

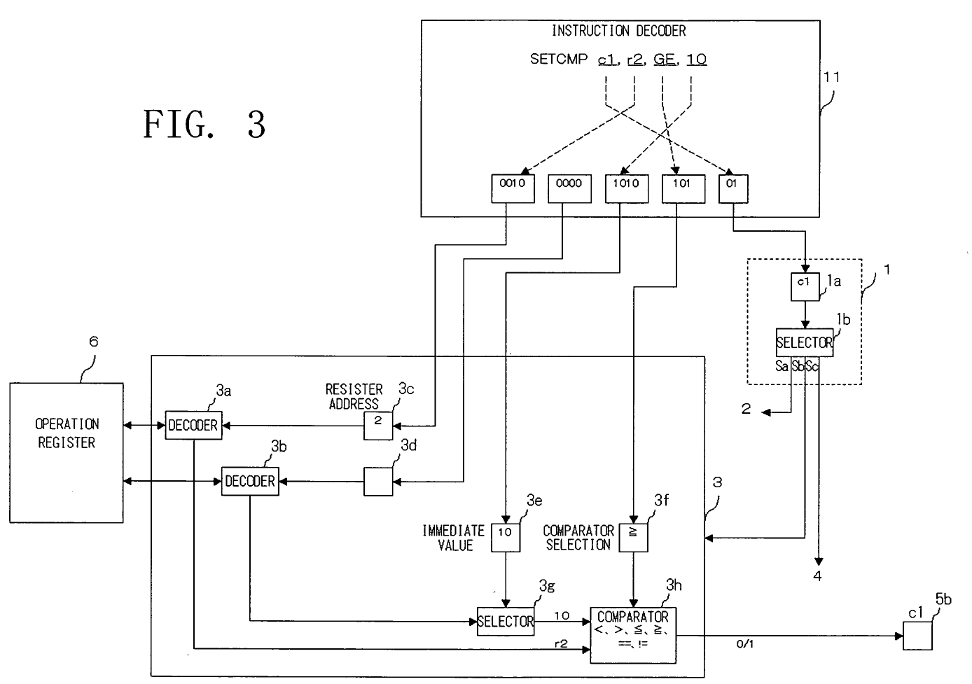

In operation, the instruction is processed in the same manner as the first condition setting instruction as shown in 7-2 in FIG. 7 except that the immediate value 10 is stored in a register 3e in the condition setting/comparison unit 3 (see FIG. 3).

As a result, the following values are stored in the condition setting/comparison unit 3 as shown in FIG. 3.

The register 3c stores the register address 2 (0010b) that indicates the operation register r2.

The register 3e stores the value 10 (1010b) that indicates the immediate value 10.

The resister 3f stores the value that indicates the comparator type GE (This value is represented by 5 (101b) in Table 7, and “≧” in FIG. 2B).

In the third condition setting instruction

SETCMP c2, r3, EQ, r13

the condition setting c2 is specified to select the condition setting/comparison unit 4. This instruction is also processed in the same manner as the first instruction SETCMP c0, r1, L, r11 to perform the operation shown in 7-3 in FIG. 7.

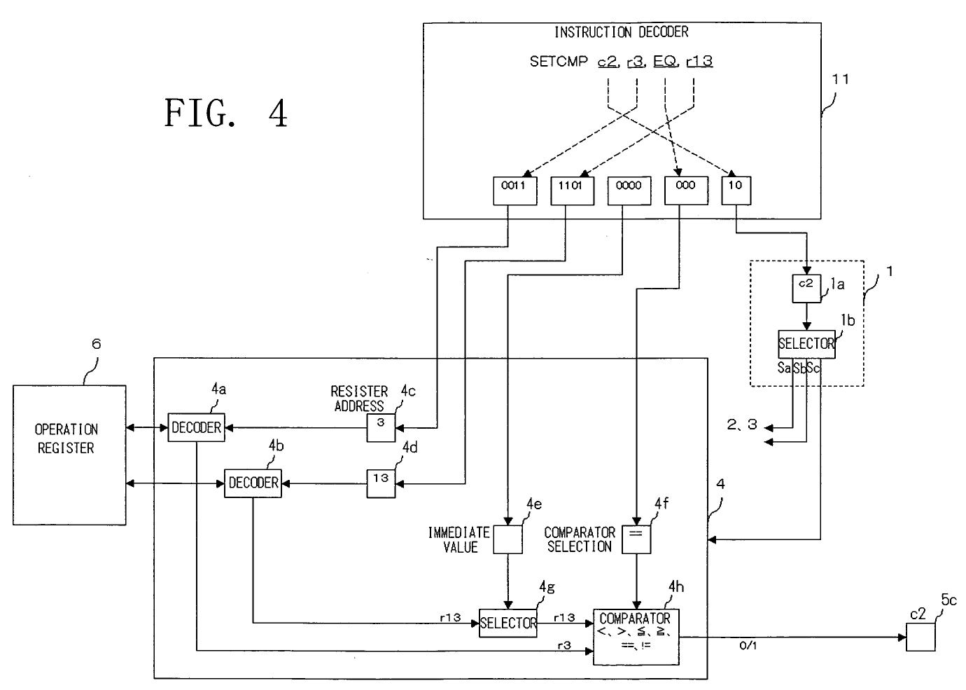

As a result, the following values are stored in the condition setting/comparison unit 4 as shown in FIG. 4.

The register 4c stores the register address 3 (0011b) that indicates the operation register r3.

The register 4d stores the register address 13 (1101b) that indicates the operation register r13.

The resister 4f stores the value that indicates the comparator type EQ (This value is represented by 0 (000b) in Table 7, and “==” in FIG. 2C).

As described above, the condition setting instructions are used in this example to set multiple conditions, which constitute the complex condition, before the complex conditional branch instruction is executed.

Note that the condition setting instruction only sets a condition but does not perform the actual comparison operation. This is because the values are not yet stored in the operation register 6, used for the comparison operation, at this point in time. The comparison operation is performed when the complex conditional branch instruction is executed.

The complex conditional branch instruction, another instruction added to the instruction set in this example, performs the comparison operation corresponding to the conditions set by the condition setting instructions and, at the same time, compares the result with a branch condition value. The complex conditional branch instruction is represented in an Assembler mnemonic as follows in the example shown in FIG. 6.

XBNE 0111b, L1

XBNE is the name of the instruction, and NE represents the type of the comparator (see Table 7). In addition to NE used in the example, EQ, L, LE, G, or GE may be used for comparison.

0111b is a branch condition value, represented in binary, that is to be compared with the comparison operation result (on a bit-by-bit basis) of each condition.

L1 represents a jump destination address in the program to which control jumps if the checking result of the complex conditional branch is true.

The following describes the operation of the complex conditional branch instruction in this example.

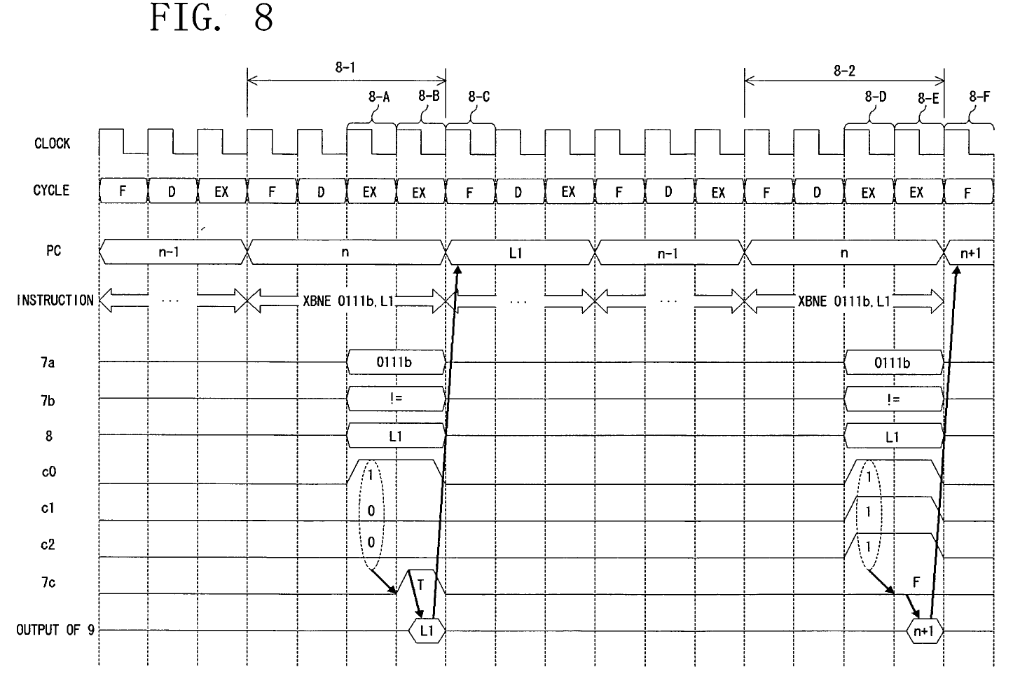

In the first complex conditional branch instruction in 8-1 in FIG. 8

XBNE 0111b, L1

the instruction code is read from the instruction memory (not shown) into the instruction decoder 11 in the instruction fetch cycle F.

In the instruction decode cycle D that follows the instruction fetch cycle F, the instruction code that has been read is analyzed by the instruction decoder 11 in FIG. 5 as shown in FIG. 5. The complex conditional branch determination unit 7 has the registers 7a and 7b and the comparator 7c.

The instruction decoder 11 decodes the instruction as follows.

NE in XBNE is decoded to 001b,

0111b is decoded directly to 0111b, and

L1 is decoded to XXXXXXXXb (value indicating the jump destination address L1)

At the same time, the instruction decoder 11 stores the following values in the complex conditional branch determination unit 7.

0111b in the register 7a and

001b, which indicates the comparison “NE”, in the register 7b (NE is represented by 1 in Table 7, and “!=” in FIG. 5).

The instruction decoder 11 also stores the jump destination address L1 in the jump destination address register 8. The values of the registers are used in the next cycle 8-A (instruction execution cycle EX of XBNE) in FIG. 8.

At the same time, the decoder 2a and the decoder 2b in the condition setting/comparison unit 2 (see FIG. 2) use the resisters 2c and 2d, which specify the specific registers in the operation register 6, to read the values from the corresponding registers (r1 and r11 in this case) in the operation register 6. The values of r1 and r11 that have been read are supplied to the comparator 2h.

The same processing is performed in the condition setting/comparison unit 3 and the condition setting/comparison unit 4. Referring to FIG. 3, the value of the register in the operation register 6 specified by a decoder 3a is read. In the condition setting/comparison unit 3, the value of the register r2, which is one of the operation registers 6 selected by the register 3c, is read. After that, the value of the register r2 and the value 10 in the immediate value register 3e, selected by a selector 3g, are supplied to a comparator 3h.

Referring to FIG. 4, decoders 4a and 4b in the condition setting/comparison unit 4 use address registers 4c and 4d, which specify the specific registers in the operation register 6, to read the values from the corresponding operation registers 6 (r3 and r13 in this case) from the operation register 6. The values of the registers, r3 and r13, in the operation register 6, which have been read, are supplied to a comparator 4h.

In the instruction execution cycle EX of XBNE (8-A in FIG. 8), the comparator 2h in the condition setting/comparison unit 2 (see FIG. 2) uses the values of the two operation registers, which have been read into the decoders 2a and 2b, to perform the comparison operation via the comparator specified by the comparator selection register 2f and then stores the result in a register 5a (see FIG. 5).

In this case, if one of the values to be compared is an immediate value as in the condition setting/comparison unit 3, the selector 3g (FIG. 3) selects the value of the register 3e (FIG. 3) and passes the selected value to the comparator 3h for use in the comparison operation. The same processing is performed also in the condition setting/comparison unit 4.

The operation result of the comparator 2h of the condition setting/comparison unit 2, the operation result of the comparator 3h of the condition setting/comparison unit 3, and the operation result of the comparator 4h of the condition setting/comparison unit 4 are stored, respectively, in the registers 5a-5c.

Referring to FIG. 5,the comparator 7c compares the registers 5a-5c, in which the comparison operation results are stored, with the branch condition value (value of register 7a) obtained from the operation code in the next instruction execution cycle EX (8-B in FIG. 8). Note that, following the instruction fetch cycle F and the decoding cycle D, the complex conditional branch instruction includes two instruction execution cycles EX (In the first instruction execution cycle EX, the condition setting/comparison units 2, 3, and 4 perform the comparison operation and set the results in the registers 5 (5a, 5b, 5c); in the second instruction execution cycle EX, the comparator 7c compares the value of the registers 5 with the branch condition value to see if a branch occurs).

The type of the comparator used in this example is NE (1 (001b) in Table 7, and “!=” in FIG. 3) selected by the register 7b.

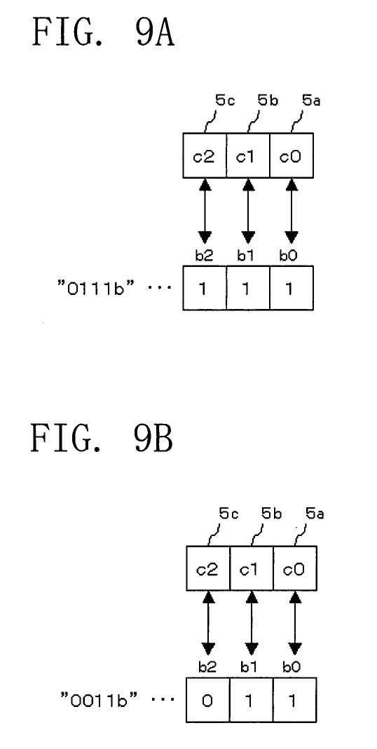

As shown in FIG. 9A, the registers 5a, 5b, and 5c are made to correspond to bits 0, 1, and 2 of the branch condition value stored in the register 7a. If the branch condition value stored in the register 7a is 0011b, the correspondence is as shown in FIG. 9B.

In the next instruction execution cycle EX (8-B in FIG. 8) of XBNE, the operation result output T/F of the comparator 7c is T, indicating that all conditions of the complex condition are not true. Therefore, the selector 9 selects the address stored in the jump destination address register 8 and sets the selected address in the program counter 10.

At this time, the address value stored in the jump destination address register 8 is output to the instruction memory bus and, in the next instruction fetch cycle, the instruction stored at address L1 is read from the instruction memory (8-C in FIG. 8).

After that, when the complex conditional branch instruction “XBNE 0111b, L1” is executed again (8-2 in FIG. 8), the processing is executed in the same manner as before. This time, because all the conditions are true as shown in 8-D in FIG. 8 (instruction execution cycle EX of XBNE), the operation result output T/F of the comparator 7c (see FIG. 3) is F. Therefore, the selector 9 selects the address (n+1) of the next instruction and sets the selected address in the program counter 10.

At this time, the address value of the next instruction is output to the instruction memory bus and, in the next instruction fetch cycle, the instruction immediately following the complex conditional branch instruction “XBNE 0111b, L1” is read from the instruction memory not shown (8-F in FIG. 8).

With multiple conditions set in advance by the condition setting instructions as described above, the complex conditional branch instruction perform the comparison operation for multiple conditions and, after that, compares the result of the comparison with a specified branch condition value to determine whether to cause a branch to be taken or not. In this way, a conditional branch depending on multiple conditions can be executed by one instruction.

The following describes the effect of this example by comparing the example with the conventional scheme described in Patent Document 1.

The comparison instruction and the conditional branch instruction are always combined in the conventional scheme described above to perform a conditional branch, while the conditions used for a conditional branch are set in advance in this example to allow one conditional branch instruction to perform conditional branch processing. Therefore, the method in this example is suitable for high-speed processing. In particular, the method in this example, if applied to a repeated execution under the same conditions, provides faster processing than the conventional scheme. In addition, the complex conditional branch instruction that performs comparison processing for multiple conditions in parallel increases the processing speed.

When all complex conditions are represented in one instruction as in the conventional scheme, the instruction has multiple operands and the instruction length becomes longer. In a system where the bus width of the instruction memory is relatively narrow, the operand, if too long, requires an additional cycle to fetch the instruction.

In contrast, the condition setting instruction, which is separate from the conditional branch instruction, is used in this example to set conditions and, therefore, the condition setting instruction and the conditional branch instruction can be implemented in an instruction length almost equal in size to the standard comparison instruction and the conditional branch instruction. This means that, even in a system where the instruction memory width is relatively narrow, an additional instruction fetch cycle is not necessary in many cases. This is because this example provides the condition setting instruction that sets multiple conditions in advance and the complex conditional branch instruction that compares the operation result of the complex conditions, which have been set, with a branch condition to determine whether to cause a branch to be taken or not.

In this example, only one complex conditional branch instruction is executed during the conditional branch processing and, so, the execution cycle is required for one instruction only. Therefore, this method can perform a conditional branch faster than the conventional scheme in which two instructions are used.

In addition, this example has a configuration comprising the selector 1 that allows conditions to be set one by one, the resisters 2c-2f that store complex conditions, and the decoders 2a and 2b that acquire the values from the operation register 6. This configuration enables the complex condition comparison operation to be executed during the execution of the complex conditional branch instruction.

The example described above has the, following effects (advantages).

The conventional scheme, in which two instructions (complex condition comparison instruction and conditional branch instruction) are combined, requires the instruction fetch cycle and the instruction decode cycle twice.

In contrast, the same result can be obtained by one conditional branch instruction in this example, meaning that the instruction fetch and the instruction decoding are required once and that the number instruction cycles is reduced and the processing speed becomes higher. For the conditional branch processing that is performed only once, it appears that the conventional scheme is faster because, in this example, each of multiple conditions is set in advance by the condition setting instruction. However, when the same complex condition is repeated many times, the method according to the present invention becomes faster as the number of repetitions increases.

The operand part of the complex condition comparison instruction in the conventional scheme is long because multiple conditions are specified all by one instruction. Therefore, if the bus width of the instruction memory is narrower than the instruction length, an additional instruction fetch cycle is required with the result that the number of instruction execution cycles is increased.

In contrast, because one condition is specified by one instruction basically in this example, the instruction length is almost equal to that of other standard operation instructions. For this reason, the method in this example eliminates the need for an additional instruction fetch cycle in most cases and therefore does not increase the number of execution cycles.

Although a binary comparison operation, in which numeric values are compared, is used as an example of the condition of a conditional branch instruction in the above example, the present invention is of course applicable not only to the comparison operation between 2 terms but also to a conditional branch determined by a flag (zero flag, carrier flag) of the processor. A logical operation can of course be used for the comparison operation of a condition.

While the present invention has been described with reference to the example above, it is to be understood that the present invention is not limited to the configuration of the example above and that modifications and changes that may be made by those skilled in the art within the scope of the present invention are included.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A processor apparatus comprising:
an instruction set that includes:
a conditional branch instruction that causes a branch to a branch destination to be taken, depending upon whether or not a condition is true; and
a condition setting instruction that sets the condition;
a circuit that, when executing the condition setting instruction, sets a condition specified by the condition setting instruction, but does not perform a comparison operation corresponding to the condition; and
a circuit that, when executing the conditional branch instruction, performs the comparison operation corresponding to the condition, which has been set in advance by the condition setting instruction, to determine whether to cause a branch to the branch destination to be taken or not, based on a result of the comparison operation.

2. The apparatus according to claim 1, wherein
the conditional branch instruction is a complex branch condition instruction having a complex condition composed of a plurality of conditions for determining whether to cause the branch to be taken or not;
a plurality of the condition setting instructions are executed to set the conditions of the complex condition; and
when the complex conditional branch instruction is executed, a plurality of comparison operations corresponding to respective ones of the plurality of the conditions, which have been set in advance are executed, in parallel, and, based on a result of the plurality of comparison operations, determines whether to cause the branch to be taken or not, whereby conditional branch processing based on the complex condition is performed by one complex conditional branch instruction.

3. A processor apparatus comprising:
an instruction set that includes:
a complex conditional branch instruction that performs comparison operations corresponding to one or more conditions and causes a branch to a specified branch destination to be taken, based on a comparison operation between a result of the comparison operations and a specified branch condition value; and
a condition setting instruction that sets a condition;
a plurality of condition setting/comparison units each of which is selected by an execution of the condition setting instruction, in each of which a condition specified by the condition setting instruction is set and, when the complex conditional branch instruction is executed, each of which performs a comparison operation corresponding to the condition specified by the condition setting instruction; and
a complex conditional branch determination unit that determines, when the complex conditional branch instruction is executed, whether to cause the branch to the branch destination to be taken or not, based on a result of a comparison between a result of the comparison operations of said plurality of condition setting/comparison units and the branch condition value specified by the complex conditional branch instruction.

4. The apparatus according to claim 3, wherein
the condition setting instruction includes, in an operand thereof, a specification of the condition setting/comparison unit, a type of comparison operation, and registers in an operation register or a register in the operation register and immediate data to be used in the comparison operation.

5. The apparatus according to claim 3, wherein
the complex conditional branch instruction includes a type of comparison operation in an op code, and the branch condition value and the branch destination in an operand.

6. The apparatus according to claim 3, wherein
the condition that is set in said condition setting/comparison unit by the execution of the condition setting instruction is held until another condition setting instruction is executed after the condition setting instruction, said condition setting/comparison unit is selected again by said another condition setting instruction, and the condition is rewritten by another condition.

7. The apparatus according to claim 3, wherein
said condition setting/comparison unit comprises:
first and second address registers that store address information on two operation registers to be compared;
an immediate value register that stores immediate value data;
a comparator selection register that stores a type of comparison operation;
a comparator; and
first and second decoders that decode addresses of said first and second address registers; wherein
when the condition setting instruction is executed, values are set in said first and second address registers or in said first address register and said immediate value register, and in said comparator selection register; and
when the complex conditional branch instruction is executed, said operation registers specified by said first and second address registers, or said operation register specified by said first address register, is read and the values of the two operation registers read by the specification of the first and second address registers are compared, or the value of said operation register read by the specification of said first address register is compared with the immediate value data, by said comparator.

8. The apparatus according to claim 3, further comprising
a plurality of registers in which results of the comparison operations by said plurality of condition setting/comparison units are saved.

9. The apparatus according to claim 8, wherein
said complex conditional branch determination unit comprises:
a first register that receives an output from an instruction decoder that decodes the complex conditional branch instruction and stores the branch condition value specified by the complex conditional branch instruction;
a second register that stores the type of comparison operation; and
a comparator that outputs a comparison result by performing a comparison operation, specified by said second register, for outputs of said plurality of registers, in which the results of the comparison operations by said plurality of condition setting/comparison units are saved, and the branch condition value specified by said first register.

10. The apparatus according to claim 3, further comprising
a selector that selects the condition setting/comparison unit specified by the condition setting instruction, based on a decoding result of the condition setting instruction by the instruction decoder.

11. The apparatus according to claim 10, further comprising:
a jump destination address register that stores a jump destination address specified by the complex conditional branch instruction decoded by said instruction decoder; and
a selector that receives a true/false value, which is a result output from said complex conditional branch determination unit, selects the jump destination address if the true/false value is true, selects an address produced by adding one to a program counter value if the true/false value is false, and sets the selected address in said program counter.

12. A conditional branch processing method for use by a processor wherein said processor comprises an instruction set that includes:
a conditional branch instruction that causes a branch to a branch destination to be taken, depending upon whether or not a condition is true; and
a condition setting instruction that sets the condition, said method comprising the steps of:
setting a condition specified by the condition setting instruction, but without performing a comparison operation corresponding to the condition, when the condition setting instruction is executed; and
performing the comparison operation corresponding to the condition, which has been set in advance by the condition setting instruction, to determine whether to cause the branch to the branch destination to be taken or not, based on a result of the comparison operation, when the conditional branch instruction is executed.

13. The method according to claim 12, wherein
the conditional branch instruction is a complex branch condition instruction having a complex condition composed of a plurality of conditions for determining whether to cause the branch to be taken or not;
a plurality of the condition setting instructions are executed to set the conditions of the complex condition; and
when the complex conditional branch instruction is executed, the conditional branch instruction executes comparison operations corresponding to the plurality of the conditions, which have been set in advance, in parallel and, based on a result of the plurality of the comparison operations, determines whether to cause the branch to be taken or not, whereby conditional branch processing based on the complex condition is performed by one complex conditional branch instruction.
